(19) United States
(12) Patent Application Publication
(10) Pub. No.: US 2014/0146342 A1
(43) Pub. Date: May 29, 2014

(54) IMAGE FORMING APPARATUS, CONTROL METHOD THEREOF, AND STORAGE MEDIUM STORING A PROGRAM

(71) Applicant: CANON KABUSHIKI KAISHA, Tokyo (JP)

(72) Inventors: Yoko Ishii, Kawasaki-shi (JP); Yoshiro Tachibana, Inagi-shi (JP)

(21) Appl. No.: 14/079,935

(22) Filed: Nov. 14, 2013

(30) Foreign Application Priority Data
Nov. 29, 2012 (JP) 2012-261631

(51) Int. Cl. G06K 15/00

(52) U.S. Cl. CPC G06K 15/4085
USPC 358/1.14

(57) ABSTRACT

When an event requiring maintenance in an apparatus has been detected, moving image reproducing, for starting reproducing of a moving image indicating a procedure of maintenance in response to a user instruction and reproducing, is executed. Then, when it is determined that the procedure indicated by the moving image is executed, reproducing of a moving image indicating a procedure for clearing the event is executed.

### BACKGROUND OF THE INVENTION

1. Field of the Invention

The present invention relates to image forming apparatuses that display operation sequences during maintenance, and to control methods thereof and storage media that store programs.

2. Description of the Related Art

An image forming apparatus has been proposed where, in the case where a paper jam has occurred, a process for replacing toner is required, or the like, an operation sequence for addressing the situation is displayed in a display unit provided in a console unit and an operator is then prompted to carry out processing. Operation instructions that employ moving images are particularly suited to explaining such sequences in detail, and thus it is easy even for relatively inexperienced users to address such situations by following the operation instructions. Japanese Patent Laid-Open No. 8-69223 discloses a technique in which a user manipulates a “next process key” provided in a console unit in order to advance to moving images data indicating a subsequent operation and display that moving image data in the console unit. Japanese Patent Laid-Open No. 8-69223 also proposes a method in which the user manipulates an “auto next process key” in order to automatically switch to and display subsequent image data indicating an operation sequence.

However, with operational instructions such as those proposed by Japanese Patent Laid-Open No. 8-69223, when switching to a screen indicating the next operation, the moving image indicating that operation is automatically reproduced at the same time the switch occurs. Accordingly, there are cases where the user takes his/her eyes off the display in the console unit in order to close a cover, confirm the location of a paper jam, or the like, and the moving image has already advanced partway along or finished completely by the time the user returns his/her eyes to the console unit. In such a case, the user may miss part of the operation sequence. Having missed part of the operation sequence, it is then necessary for the user to carry out operations such as reversing through the moving images. Meanwhile, in the case where jams have occurred in multiple locations, the moving images advance to the operations for clearing the jam at the next location even if the jam in a previous location has not yet been cleared. Thus in the case where, for example, an order of priority is set for the sequence for handling the paper jams, the user will be prompted to perform the operations in the wrong order, which can lead to device breakdowns and the like.

### SUMMARY OF THE INVENTION

An aspect of the present invention is to eliminate the above-mentioned problems with the conventional technology.

The present invention provides a technique for, in the case where a user operation is required, displaying a moving image instructing that operation in a stopped state and then starting the reproduction of that moving image at a timing desired by the user.

The present invention in one aspect provides an image forming apparatus, the apparatus comprising: a detecting unit configured to detect an occurrence of an event requiring maintenance in the image forming apparatus; a manual moving image reproducing unit configured to start reproducing of a moving image indicating a procedure of maintenance in response to an instruction from a user; a determination unit configured to determine whether or not the procedure indicated by the moving image has been executed; and a control unit configured to cause the manual moving image reproducing unit to execute reproducing of a moving image indicating a procedure for opening a cover corresponding to a location where the event occurred in response to the detection of the event by the detecting unit, and in a case where the determination unit determines that the cover is opened, cause the manual moving image reproducing unit to execute reproducing of a moving image indicating a procedure for clearing the event.

According to the present invention, a user can start reproduction of a moving image at a desired timing, and thus the user will not miss an operation instructed by the moving image. Furthermore, instructions can be made in order from operations higher in an order of priority, providing an effect that the user need not worry about device breakdowns caused by mistakes in the sequence.

Further features of the present invention will become apparent from the following description of exemplary embodiments with reference to the attached drawings.

### BRIEF DESCRIPTION OF THE DRAWINGS

FIG. 1 is a block diagram illustrating the configuration of an image output system.

FIG. 2 is a block diagram illustrating the configuration of a control unit in an image forming apparatus.

FIG. 3 is a block diagram illustrating the configuration of peripheral elements in the image forming apparatus, including a console unit.

FIG. 4 is a plan view of the console unit in the image forming apparatus.

FIG. 5 is a cross-sectional view illustrating the configuration of the image forming apparatus.

FIG. 6 is a diagram illustrating an example of a screen instructing a user to clear a paper jam, displayed in the console unit of the image forming apparatus.

FIGS. 7A and 7B are flowcharts illustrating a process for displaying a moving image specifying an operation sequence in the image forming apparatus.

FIG. 8 is a flowchart illustrating a process for displaying a moving image indicating an operation sequence performed when a paper jam has occurred in the image forming apparatus.

FIG. 9 is another flowchart illustrating a process for displaying a moving image indicating an operation sequence performed when a paper jam has occurred in the image forming apparatus.

FIGS. 10A and 10B are another flowcharts illustrating a process for displaying a moving image indicating an operation sequence performed when a paper jam has occurred in the image forming apparatus.

FIG. 11 is a flowchart illustrating a process for displaying a moving image indicating a sequence for clearing a paper jam in the image forming apparatus.

FIG. 12 is another flowchart illustrating a process for displaying a moving image indicating a sequence for clearing a paper jam in the image forming apparatus.

FIG. 13 is another flowchart illustrating a process for displaying a moving image indicating a sequence for clearing a paper jam in the image forming apparatus.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that identical constituent elements will be given identical reference numerals, and descriptions thereof will be omitted.

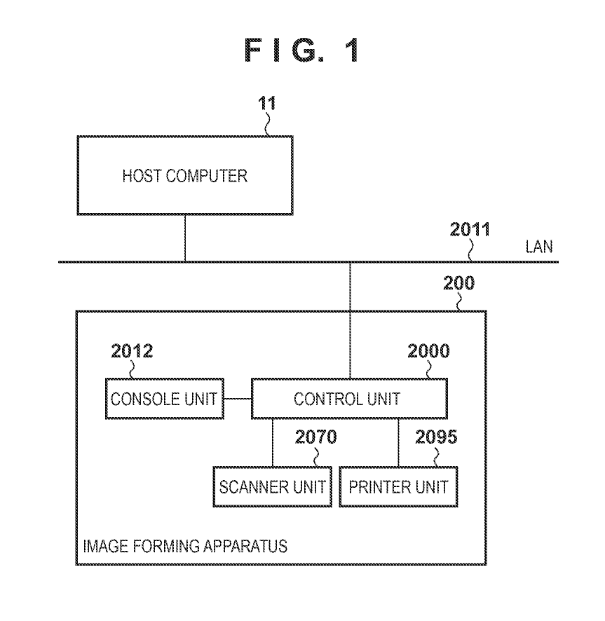

FIG. 1 is a block diagram illustrating the configuration of an image output system according to embodiments of the present invention. In this image output system, a host computer 11 and an image forming apparatus 200 are connected via a LAN 2011. Note that a plurality of image forming apparatuses may be connected to the LAN 2011, and the host computer 11 and the image forming apparatuses can communicate according to a predetermined protocol. Note that an image output system that combines such image forming apparatuses and information processing apparatuses also falls within the scope of the present invention.

The image forming apparatus 200 includes a scanner unit 2070 serving as an image input device, a printer unit 2095 serving as an image output device, a control unit 2000, and a console unit 2012 serving as a user interface. The host computer 11 is an information processing apparatus that functions as a client machine, and includes a display unit, a keyboard, a pointing device, a main computer unit, and the like. The host computer 11 loads an operating system from an external storage device provided in the main computer unit into a RAM and executes various types of application programs. In addition, the host computer executes what is known as web browser software that communicates over a network via a network card and displays information obtained through the communication, and is configured to be capable of communicating with the image forming apparatus 200, which functions as a web server, according to a predetermined protocol.

The scanner unit 2070, the printer unit 2095, and the console unit 2012 are each connected to the control unit 2000, and the control unit 2000 is connected to a network transmission unit such as the LAN 2011.

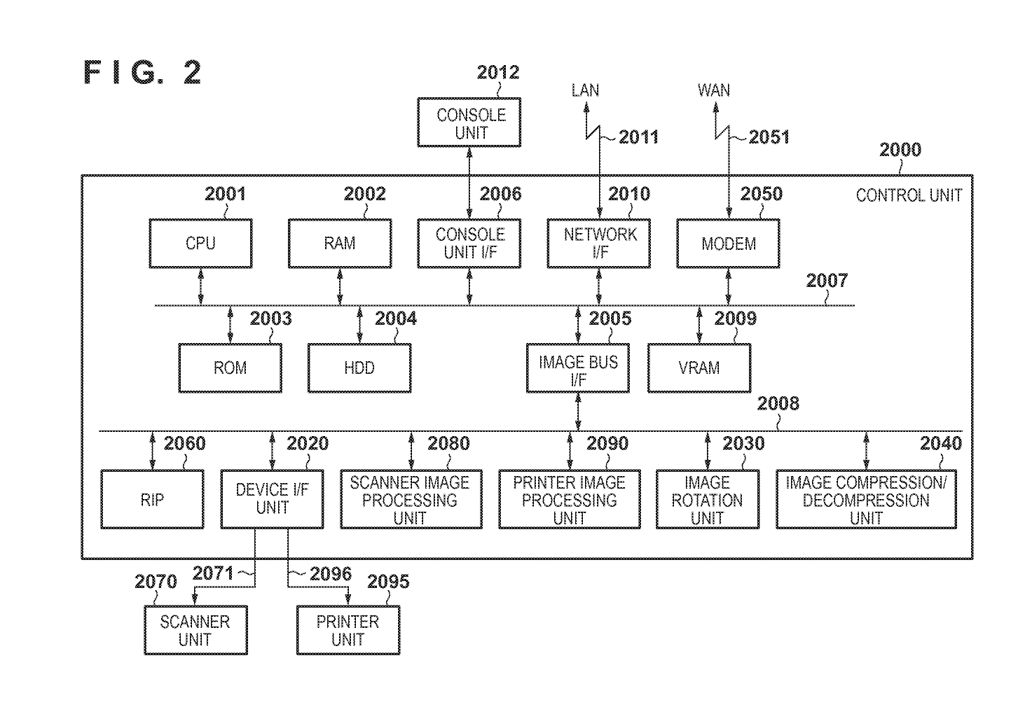

FIG. 2 is a block diagram illustrating the configuration of the control unit 2000 of the image forming apparatus 200 according to the embodiments.

The control unit 2000 inputs/outputs image information, device information, and the like by connecting to the scanner unit 2070, the printer unit 2095, and so on via a device interface unit 2020 and by connecting to the LAN 2011, a wide-area network (WAN) 2051, and the like.

A CPU 2001 controls the image forming apparatus 200 as a whole in accordance with programs loaded into a RAM 2002. The RAM 2002 is used as a working memory into which the programs executed by the CPU 2001 are loaded and which stores various types of data, and is also used as an image memory for temporarily storing image data. A ROM 2003 functions as a boot ROM, and when the image forming apparatus 200 is turned on, the CPU 2001 executes a boot program in the ROM 2003 and loads an OS, programs, and the like installed in an HDD 2004 into the RAM 2002. An HDD 2004 is a hard disk drive (HDD), and stores an OS, system software, image data, and the like. A console unit I/F 2006 functions as an interface with the console unit 2012, and serves to output image data to be displayed in the console unit 2012 to the console unit 2012 and communicate information input by a user through the console unit 2012 to the CPU 2001. A VRAM 2009 holds image data generated by the CPU 2001 to be displayed in the console unit 2012. A network interface 2010 inputs/outputs information via the LAN 2011. A modem 2050 is connected to the wide-area network 2051, and inputs/outputs information. The aforementioned devices are connected to a system bus 2007.

An image bus interface 2005 is a bus bridge that connects to an image bus 2008 for transferring image data with the system bus 2007 at high speeds, and converts data structures between these buses. The image bus 2008 is configured of a PCI bus or according to the IEEE 1394 standard, and the following devices are provided on the image bus 2008.

A raster image processor (RIP) 2060 expands PDL code into a bitmap image. The device interface unit 2020 is connected to the scanner unit 2070 and the control unit 2000 via an image input unit interface 2071, and is connected to the printer unit 2095 and the control unit 2000 via a printer unit interface 2096. The device interface unit 2020 performs synchronous/asynchronous conversion of image data between these elements. A scanner image processing unit 2080 performs correction, processing, editing, and so on on the image data input from the scanner unit 2070. A printer image processing unit 2090 performs correction, resolution conversion, and so on on the image data output from the printer unit 2095. An image rotation unit 2030 rotates image data. An image compression/decompression unit 2040 performs compression/decompression processes using, for example, the JPEG format for multi-valued image data and the JBIG, MMR, or MH format for binary image data.

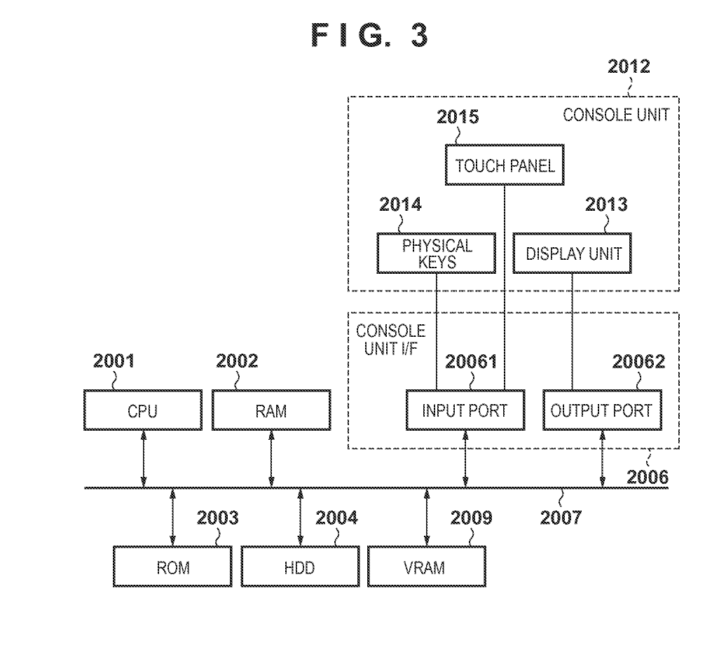

FIG. 3 is a block diagram illustrating the configuration of peripheral elements, including the console unit 2012, of the image forming apparatus 200 according to the embodiments; areas that are the same as those shown in FIGS. 1 and 2 are given the same reference numerals, and descriptions thereof will be omitted.

The console unit 2012 includes a touch panel 2015, physical keys 2014, and a display unit 2013. The console unit I/F 2006 includes an input port 20061 for inputting information input through the touch panel 2015, the physical keys 2014, or the like, and an output port 20062 for outputting data to the display unit 2013. The CPU 2001 generates display data based on a control program and holds the display data in the VRAM 2009, and the display data is output to and displayed in the display unit 2013, which is a liquid-crystal display, a CRT display, or the like, via the output port 20062. Moving image data that displays moving images, which will be mentioned later, is also held in the VRAM 2009, and is output to and displayed in the display unit 2013 via the console unit I/F 2006.

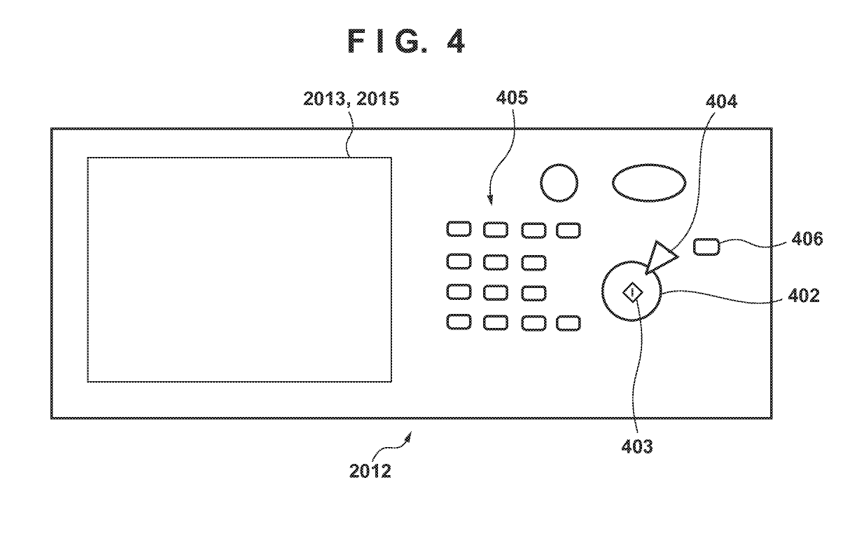

FIG. 4 is a plan view of the console unit 2012 in the image forming apparatus according to the embodiments.

The display unit 2013 is configured by affixing a touch panel sheet upon a liquid crystal panel, and thus serves as the touch panel 2015; the display unit 2013 displays operation screens and software keys, and when a key that is being displayed is pressed, communicates information of the position of that key to the CPU 2001. A start key 402 is used when making instructions for starting the reading of an original document, starting the transmission of a facsimile, and so on. A two-color LED 403, capable of displaying green and red, is provided in a central area of the start key 402, and whether or not the start key 402 can be used is indicated by those colors. A stop key 404 stops operations currently being carried out when pressed. A numerical keypad 405 is configured of a numerical and text-based button group, and is used to input telephone numbers and instructions such as setting a number of copies, switching among screens in the display unit 2013, and so on. A user mode key 406 is used for making device configurations.

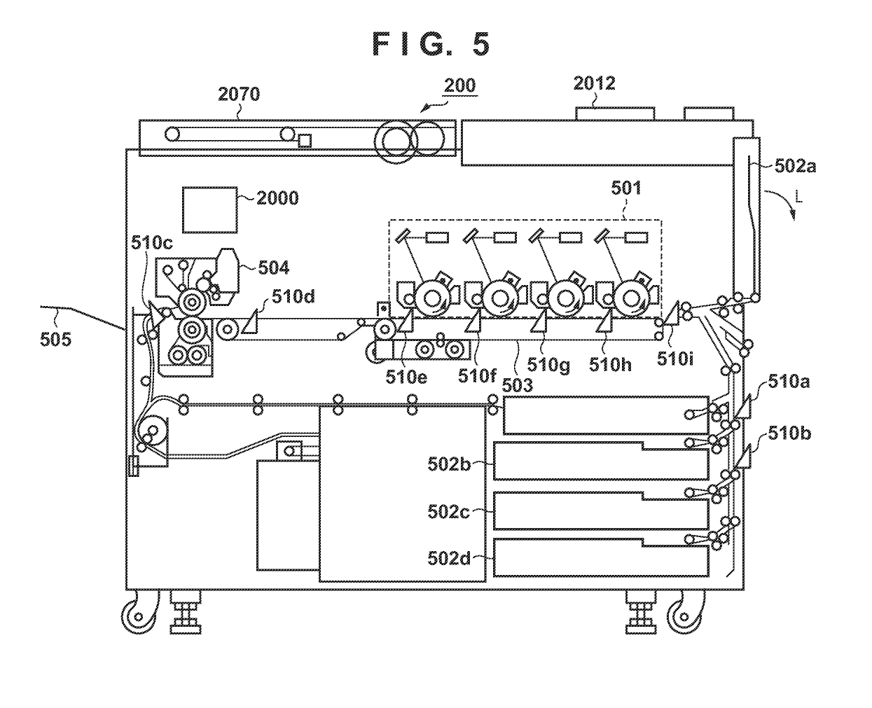

FIG. 5 is a cross-sectional view illustrating the configuration of the image forming apparatus 200 according to the embodiments.

The image forming apparatus 200 includes an image forming unit 501, paper supply units 502a, 502b, 502c, and 502d, a transfer belt 503, a fixing unit 504, and a paper discharge unit 505. The image forming apparatus 200 also includes the control unit 2000, the scanner unit 2070, and the console unit 2012. Furthermore, the image forming apparatus 200 includes sensors 510a, 510b, 510c, 510d, 510e, 510f, 510g, 510h, and 510i for detecting whether or not a printing medium (sheet) is present. The paper supply unit 502a is a manual tray, and is opened in the direction of an arrow L, after which the printing medium is inserted thereinto. The plurality of paper supply units 502 (502b to 502d) each hold printing media in a stacked state, and the printing media stacked therein are picked up and fed by paper feed rollers. The image forming unit 501 includes image forming stations that form magenta, cyan, yellow, and black toner images, respectively. Each image forming station forms a developer image with a corresponding toner, after which the developer images corresponding to each color are sequentially transferred onto the printing medium that is transported along the transfer belt 503. Thereafter, the printing medium is transported to the fixing unit 504, where the developer images formed upon the printing medium are heated and melted, thus fixing those images onto the printing medium. When the developer images have been fixed in this manner, the printing medium is discharged to the paper discharge unit 505.

The control unit 2000 executes an image forming (printing) process based on a received print job by controlling these processes of the image forming apparatus 200. The scanner unit 2070 obtains color-by-color image signals by optically scanning an original document placed on a document glass and reading the document. Meanwhile, the console unit 2012 inputs commands from an operator, and displays status information, notification details, and so on to the operator. The console unit 2012 according to the embodiments may also communicate the occurrence of paper jams during image forming, and output information indicating a forming result including identification information identifying the image forming process.

The sensors 510 (510a to 510i) are, as shown in FIG. 5, disposed in plural along a conveyance path, and detect whether or not the printing medium is present. Note that the sensors 510 may be sensors that use mechanical flags, or may be sensors that use optical elements. Note also that the present descriptions of the sensors 510 merely indicate one example of the application thereof, and the positions where the sensors 510 are disposed are not limited to the embodiments. For example, in the case where all of the printing media backed up within the image forming apparatus 200 when a paper jam has occurred are to be detected, it is desirable for the sensors 510 to be disposed at the location of each image forming process (for example, paper feed locations, image forming locations, fixing locations, and the like), or at equal intervals along the conveyance path. Note that the aforementioned printer unit 2095 is configured of the image forming unit 501, the paper supply units 502, the transfer belt 503, the fixing unit 504, the paper discharge unit 505, and so on. Furthermore, although not shown in FIG. 5, a plurality of sensors for detecting covers of the image forming unit 501, paper supply units 502, paper discharge unit 505, and so on being opened/closed are also provided.

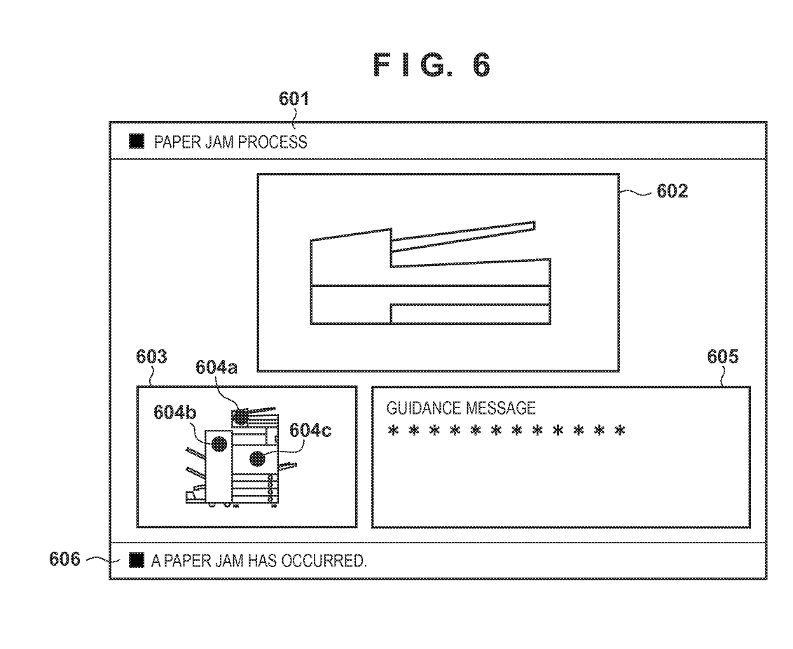

FIG. 6 is a diagram illustrating an example of a screen instructing a user to clear a paper jam, displayed in the console unit 2012 of the image forming apparatus 200 according to embodiments of the present invention.

This screen is displayed in the display unit 2013 when a paper jam has been detected. A screen title 601 indicates a title prompting the paper jam to be cleared; here, the text “paper jam process” is displayed. A moving image display region 602 displays, as moving images, an operation sequence through which the user clears the paper jam that has occurred. Note that the configuration may be such that an instruction for manually reproducing the moving images is started by the user touching the moving image displayed in the moving image display region 602. Alternatively, the configuration may be such that a reproduction start button is provided in the console unit 2012 and the user starts the reproduction by pressing the button. A paper jam location display region 603 displays a diagram indicating where in the image forming apparatus 200 the paper jam has occurred. Here, a plurality of circular marks 604a, 604b, and 604c indicating the locations where paper jams have occurred are displayed, indicating that paper jams have occurred in those locations. The circular marks 604a, 604b, and 604c are updated by being deleted when the corresponding paper jam has been cleared. For example, in the case where a paper jam indicated by the circular mark 604b has been cleared, the circular mark 604b is deleted from the paper jam location display region 603, and the circular marks 604a and 604c are left in the display. A paper jam clearance instruction text display region 605 displays, as text, an operation sequence through which the user is to clear the paper jam that has occurred. A status line 606 displays a message indicating a current status. In the case where a plurality of such statuses have occurred simultaneously, the message that is highest in an order of priority is displayed first, and the display is switched after a set time interval.

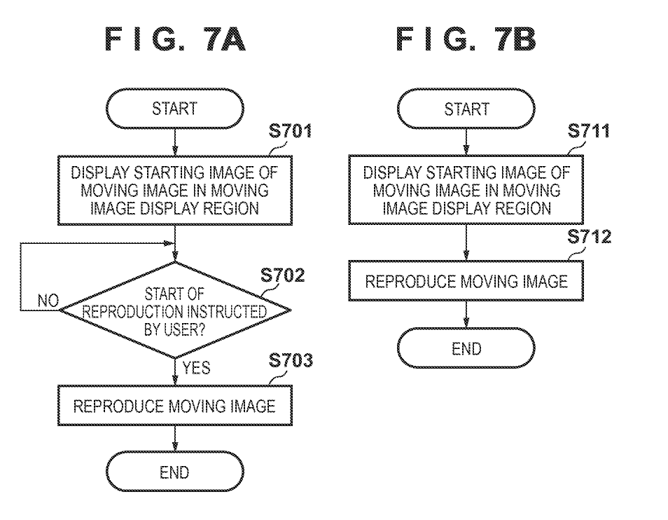

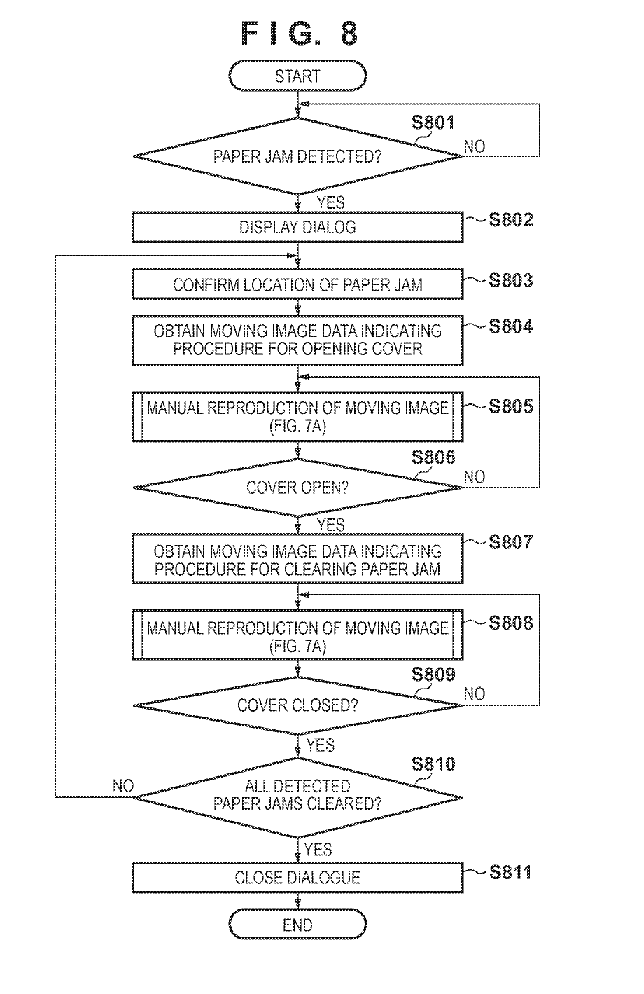

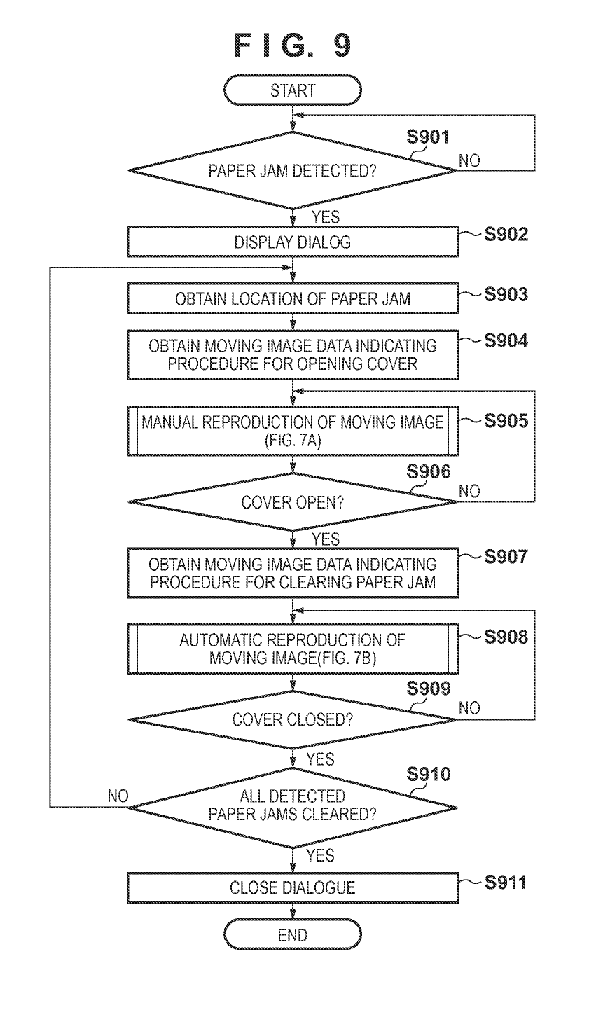

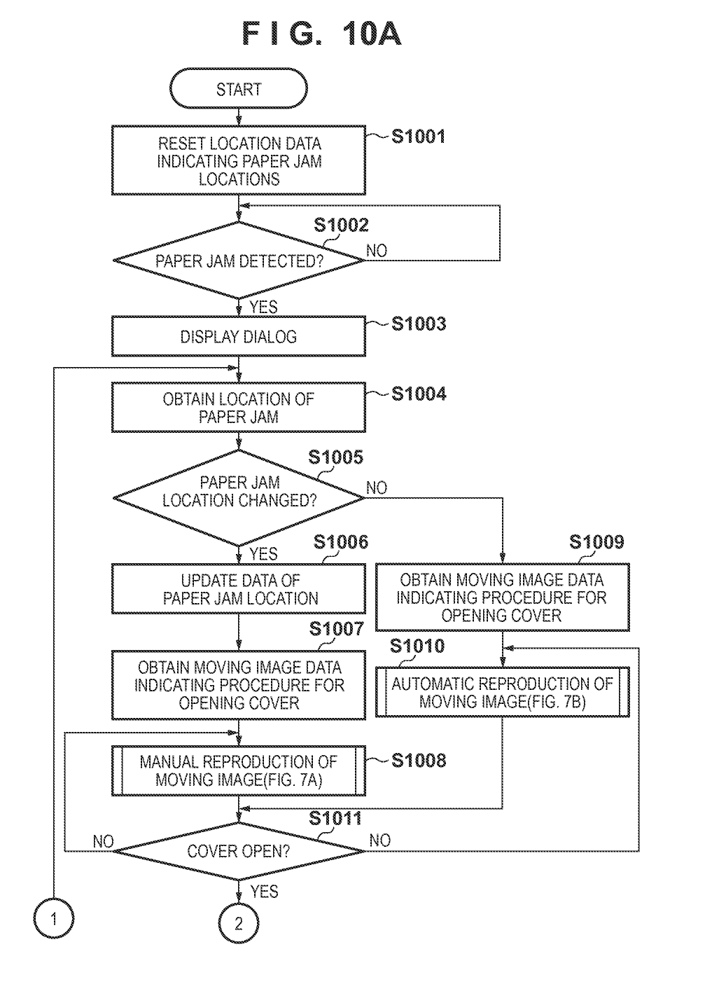

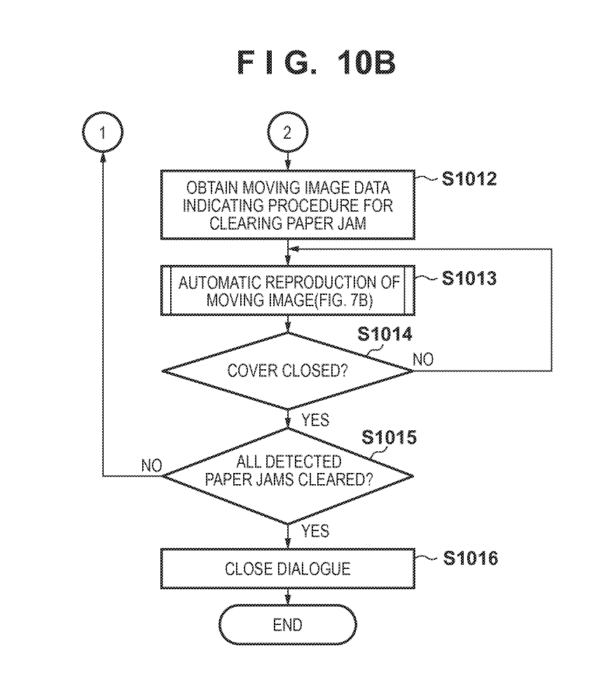

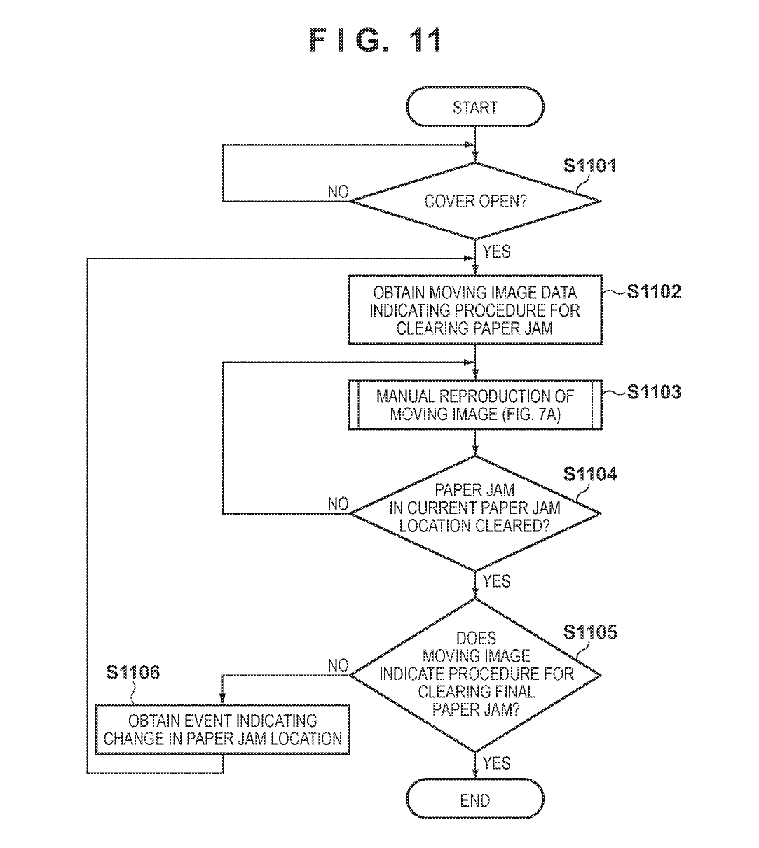

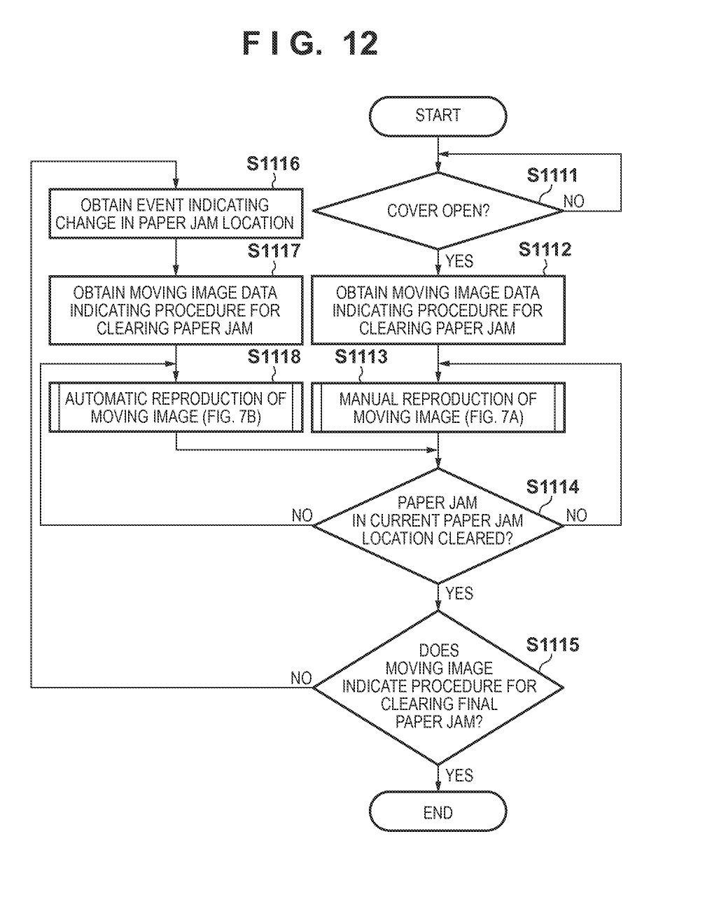

FIGS. 7A and 7B are flowcharts illustrating a process for displaying moving images specifying an operation sequence in the image forming apparatus 200 according to embodiments of the present invention. The processes indicated in this flowchart are implemented by the CPU 2001 executing programs that have been loaded from the HDD 2004 into the RAM 2002.

FIG. 7A is a flowchart illustrating a manual moving image reproduction process for manually reproducing moving images specifying an operation sequence.

This process is started by the CPU 2001 obtaining moving image data specifying the operation sequence from the HDD 2004. First, in S701, the CPU 2001 displays a starting image of the moving image (a still image) in the moving image display region 602 of the console unit 2012, based on the obtained moving image data. Then, in S702, the CPU 2001 determines whether the user has performed an operation instructing the reproduction of the moving image to start. As described earlier, the reproduction of the moving image may be instructed to start by the user touching the moving image displayed in the moving image display region 602, or a reproduction start button may be provided in the console unit 2012 and the user may perform the instruction by pressing the button. In the case where it has been determined in S702 that the reproduction of the moving image has been instructed to be started, the process advances to S703, where the CPU 2001 reproduces and displays the moving image specifying the operation sequence. On the other hand, in the case where it has been determined in S702 that an operation specifying the reproduction of the moving image to be started has not been made, the process of S702 is repeated until that instruction operation has been made.

FIG. 7B is a flowchart illustrating an automatic moving image reproduction process for automatically reproduces and displaying a moving image specifying an operation sequence.

This process is started by obtaining moving image data specifying the operation sequence from the HDD 2004. First, in S711, the CPU 2001 displays the starting image of the moving image in the moving image display region 602 of the console unit 2012, based on the obtained moving image data. Then, in S712, the CPU 2001 starts the reproduction of the moving image specifying the operation sequence and displays that moving image.

In this manner, when a moving image specifying an operation sequence is to be reproduced manually, the reproduction of the moving image is started in accordance with an instruction from the user to start the moving image reproduction; on the other hand, when the moving image is to be reproduced automatically, the reproduction of the moving image is started without waiting for an operation from the user.

### First Embodiment

FIG. 8 is a flowchart illustrating a procedure for displaying, entirely manually, a moving image specifying an operation sequence when a paper jam has occurred, in an image forming apparatus according to a first embodiment of the present invention. The processes indicated in this flowchart are implemented by the CPU 2001 executing programs that have been loaded from the HDD 2004 into the RAM 2002. Note that the processes indicated in the flowchart of FIG. 8 are started when a paper jam has occurred in the image forming apparatus 200 and a process for clearing that paper jam has become necessary.

First, in S801, the CPU 2001 determines whether or not a paper jam has occurred using sensors (the sensors 510 shown in FIG. 5) within the image forming apparatus; the process advances to S802 when a paper jam is detected. Although this flowchart illustrates S801 as being repeated until a paper jam is detected, it should be noted that the process may branch to other processes when a paper jam is not detected. In S802, the CPU 2001 displays a dialog such as that shown in FIG. 6 in the display unit 2013.

The process then advances to S803, where the CPU 2001 confirms the location of the paper jam using the sensors within the apparatus. The process then advances to S804, where the CPU 2001 obtains, from the HDD 2004, moving image data indicating a procedure for opening a cover at the location of the paper jam, which is the initial step in the operation sequence for clearing the paper jam confirmed in S803. The process then advances to S805, where the CPU 2001 executes a process for manually reproducing the moving image, in accordance with the procedure illustrated in FIG. 7A.

The process then advances to S806, where the CPU 2001 determines whether or not the cover specified by the moving image has been opened using a sensor within the apparatus; in the case where the cover has not been opened, the process returns to S805 and the moving image is reproduced, whereas in the case where it has been determined that the cover has been opened, the process advances to S807. In S807, the CPU 2001 obtains, from the HDD 2004, moving image data indicating the operation sequence for clearing the paper jam at the location of the paper jam as confirmed in S803. The process then advances to S808, where the CPU 2001 executes a process for manually reproducing the moving image, in accordance with the procedure illustrated in FIG. 7A. Then, in S809, the CPU 2001 determines whether or not the cover opened in S806 has been closed using a sensor within the apparatus; in the case where the cover has not been closed, the process advances to S808, where the reproduction and display of the moving image is repeated. Then, in S809, upon detecting that the cover has been closed, the CPU 2001 determines that the operation for clearing the paper jam is complete, and the process advances to S810. In S810, the CPU 2001 determines whether or not all of the paper jams detected in the paper jam detection performed in S801 have been cleared; in the case where all the paper jams have not yet been cleared, the process returns to S803, whereas in the case where it has been determined that all of the paper jams have been cleared, the process advances to S811. In S811, the CPU 2001 closes the dialogue indicated in FIG. 6, and ends the processing.

According to the first embodiment described above, the reproduction and display of the moving images indicating the procedure for clearing a paper jam, for example, is started by the user manually instructing the start of the moving image reproduction. This provides an effect that problems such as the user carrying out a different operation and missing the moving images, missing an important explanation of a procedure in the moving images, and so on can be prevented. Although the first embodiment describes an example of clearing paper jams, it should be noted that the present invention is not limited thereto, and can also be applied in the case where toner or ink is being replaced, paper has been exhausted, and so on.

### Second Embodiment

Next, a second embodiment of the present invention will be described. The second embodiment is the same as the first embodiment in that the reproduction of a moving image specifying a procedure for opening a cover when a paper jam has been detected is started in response to a manual operation performed by the user. The second embodiment differs in that a moving image indicating the procedure for clearing the paper jam is automatically reproduced after the cover has been opened. Note that the system configuration, the configuration of the image forming apparatus, and so on according to the second embodiment are the same as in the aforementioned first embodiment, and thus descriptions thereof will be omitted.

FIG. 9 is a flowchart illustrating a process for displaying moving image indicating an operation sequence performed when a paper jam has occurred in the image forming apparatus according to the second embodiment of the present invention. The processes indicated in this flowchart are implemented by the CPU 2001 executing programs that have been loaded from the HDD 2004 into the RAM 2002. Note that the processes indicated in the flowchart of FIG. 9 are started when a paper jam has occurred in the image forming apparatus 200 and a process for clearing that paper jam has become necessary.

The aforementioned first embodiment describes an example in which moving images specifying the entire operation sequence are reproduced in response to a manual instruction to start the moving images. However, it may be burdensome for users who are accustomed to maintenance operations to manually instruct the reproduction of the moving images to start every time. Accordingly, the second embodiment describes an example in which only a moving image indicating the first step in an operation sequence of a predefined group is reproduced in response to a manual operation. Moving images indicating the subsequent steps of an operation sequence are reproduced automatically in response to an event occurring in the apparatus, such as a cover being opened or closed. The “groups” referred to here are predefined as locations where a paper jam has occurred, events that have occurred, and so on. The flowchart in FIG. 9 illustrates an example of a case in which the group is defined as locations where a paper jam has occurred. For example, in the case where paper jams have occurred in three locations, groups 1 to 3 are provided, in accordance with the locations where the paper jams have occurred. The reproduction of a moving image indicating a procedure for opening the cover, which corresponds to the first moving image of each group, is started in response to a manual operation made by the user, whereas a moving image indicating procedures for clearing the paper jam is automatically reproduced in response to the cover being opened.

First, in S901, the CPU 2001 determines whether or not a paper jam is detected using sensors (the sensors 510 shown in FIG. 5) within the image forming apparatus; the process advances to S902 when a paper jam is detected. Although this flowchart illustrates S901 as being repeated until a paper jam is detected, it should be noted that the process may branch to other processes when a paper jam is not detected. In S902, the CPU 2001 displays a dialog such as that shown in FIG. 6 in the display unit 2013.

The process then advances to S903, where the CPU 2001 confirms the location of the paper jam using the sensors within the apparatus. The process then advances to S904, where the CPU 2001 obtains, from the HDD 2004, moving image data indicating a procedure for opening a cover at the location of the paper jam, which is the initial step in the operation sequence for clearing the paper jam confirmed in S903. The process then advances to S905, where the CPU 2001 executes a process for manually reproducing the moving image, in accordance with the procedure illustrated in FIG. 7A.

The process then advances to S906, where the CPU 2001 determines whether or not the cover specified by the moving image has been opened using a sensor within the apparatus; in the case where the cover has not been opened, the process returns to S905 and the moving image is reproduced, whereas in the case where it has been determined that the cover has been opened, the process advances to S907. In S907, the CPU 2001 obtains, from the HDD 2004, moving image data indicating the operation sequence for clearing the paper jam at the location of the paper jam as confirmed in S903. The process then advances to S908, where the CPU 2001 executes a process for automatically reproducing the moving image, in accordance with the procedure illustrated in FIG. 7B. Then, in S909, the CPU 2001 determines whether or not the cover opened in S906 has been closed using a sensor within the apparatus; when the cover has not been closed, the process advances to S908, where the reproduction and display of the moving image is repeated. Then, in S909, upon detecting that the cover has been closed, the CPU 2001 determines that the operation for clearing the paper jam is complete, and the process advances to S910. In S910, the CPU 2001 determines whether or not all of the paper jams detected in the paper jam detection performed in S901 have been cleared; in the case where all the paper jams have not yet been cleared, the process returns to S903, whereas in the case where it has been determined that all of the paper jams have been cleared, the process advances to S911. In S911, the CPU 2001 closes the dialogue indicated in FIG. 6, and ends the processing.

According to the second embodiment described above, the reproduction and display of the moving image indicating the initial procedure for clearing a paper jam, for example, is started by the user manually instructing the start of the moving image reproduction. This provides an effect that problems such as the user carrying out a different operation and missing the moving image, missing an important explanation of a procedure in the moving image, and so on can be prevented. Then, moving images indicating the following procedures are automatically reproduced in response to the cover being opened; the procedures are sequentially displayed without the user making individual manual operations, which ensures convenient and easy operations for users who are accustomed to maintenance operations, for example. Although the second embodiment describes an example of clearing paper jams, it should be noted that the present invention is not limited thereto, and can also be applied in any situation that requires maintenance, such as replacing toner or ink, when paper has been exhausted, and so on.

### Third Embodiment

Next, a third embodiment of the present invention will be described based on FIGS. 10A and 10B.

FIGS. 10A and 10B are flowcharts illustrating a process for displaying a moving image indicating an operation sequence performed when a paper jam has occurred in the image forming apparatus according to the third embodiment of the present invention. The third embodiment is the same as the second embodiment in that the reproduction of a moving image specifying a procedure for opening a cover when a paper jam has been detected is started in response to a manual operation performed by the user, and a moving image indicating a procedure for clearing the paper jam is reproduced automatically after the cover has been opened. However, the third embodiment differs from the second embodiment in that if, after a given paper jam has been cleared, another paper jam is present in the same location, a moving image specifying a procedure for opening a cover is reproduced automatically. Note that the system configuration, the configuration of the image forming apparatus, and so on according to the third embodiment are the same as in the aforementioned first embodiment, and thus descriptions thereof will be omitted.

The processes indicated in the flowcharts of FIGS. 10A and 10B are implemented by the CPU 2001 executing programs that have been loaded from the HDD 2004 into the RAM 2002. Note that the processes indicated in the flowcharts of FIGS. 10A and 10B are started when a paper jam has occurred in the image forming apparatus 200 and a process for clearing that paper jam has become necessary.

First, in S1000, the CPU 2001 resets location data, stored in HDD 2004, that indicates locations where paper jams have occurred. The process then advances to S1002, where the CPU 2001 determines whether or not a paper jam is detected using sensors (the sensors 510 shown in FIG. 5) within the image forming apparatus; the process advances to S1003 when it has been determined that a paper jam is detected. In S1003, the CPU 2001 displays a dialog such as that shown in FIG. 6 in the display unit 2013. Although this flowchart illustrates S1002 as being repeated until a paper jam is detected, it should be noted that the process may branch to other processes when a paper jam is not detected.

The process then advances to S1004, where the CPU 2001 obtains the location of the paper jam using the sensors (the sensors 510 in FIG. 5) within the apparatus. The process then advances to S1005, where the CPU 2001 compares the location data indicating the previous location of the paper jam held in the HDD 2004 with the location data indicating the location of the paper jam obtained in S1004, and determines whether there has been a change therein. In the case where the CPU 2001 determines in S1005 that the location of the paper jam is different from the previous location of the paper jam, the process advances to S1006, where the location data indicating the location of the paper jam held in the HDD 2004 is updated to the location data indicating the location of the paper jam obtained in S1004. The process then advances to S1007, where the CPU 2001 obtains, from the HDD 2004, moving image data indicating a procedure for opening a cover at the location of the paper jam obtained in S1004. The process then advances to S1008, where the CPU 2001 executes a process for reproducing and displaying a moving image in response to a manual operation from the user, in accordance with the procedure illustrated in FIG. 7A; the process then advances to S1011.

On the other hand, in the case where it is determined in S1005 that the location of the paper jam is not different, the process advances to S1009, where the CPU 2001 obtains, from the HDD 2004, moving image data indicating a procedure for opening a cover at the location of the paper jam obtained in S1004. The process then advances to S1010, where the CPU 2001 executes a process for automatically reproducing the moving image, in accordance with the procedure illustrated in FIG. 7B; the process then advances to S1011.

In S1011, it is determined whether or not the cover indicated by the moving image has been opened, using a sensor within the apparatus; in the case where it has been determined that the cover has been opened, the process advances to S1012, whereas when such is not the case, the process returns to S1008 or S31010, where the reproduction and display of the moving image is carried out. In S1011, in the case where the procedure illustrated in FIG. 7A is displayed and the cover is not open, the process returns to S1008, whereas in the case where the procedure illustrated in FIG. 7B is displayed and the cover is not open, the process returns to S1010. In S1012, the CPU 2001 obtains, from the HDD 2004, moving image data indicating the operation sequence for clearing the paper jam at the location of the paper jam obtained in S1004. The process then advances to S1013, where the CPU 2001 executes a process for automatically reproducing the moving image, in accordance with the flowchart illustrated in FIG. 7B. The process then advances to S1014, where the CPU 2001 determines whether or not the cover opened in S1011 has been closed, using a sensor within the apparatus; in the case where it has been determined that the cover has been closed, the process advances to S1015. In the case where the cover is not closed in S1014, the process advances to S1013, where the moving image is displayed until the cover is closed. Then, in S1015, the CPU 2001 determines whether or not all of the detected paper jams have been cleared; in the case where it has been determined that all of the paper jams have been cleared, the process advances to S1016, where the dialogue is closed. In the case where it is determined in S1015 that all of the paper jams have not been cleared, the process returns to S1004.

According to the third embodiment described above, to clear a paper jam, the reproduction and display of a moving image indicating a procedure for opening the cover is first started in response to a manual operation by the user. However, when clearing another paper jam after the first paper jam has been cleared, the moving image indicating the procedure for opening the cover at the same location again is reproduced automatically in response to an apparatus event (the cover being opened/closed). Through this, the reproduction of the moving image indicating a procedure for opening the cover at the location of the first paper jam that is cleared is started in response to a manual operation performed by the user, which has an effect that the user can be made aware in the case where the location of the paper jam to be cleared has changed.

Then, when displaying a procedure for opening the cover at the same location and clearing a paper jam, the reproduction of the moving image can be started automatically without requiring a manual operation for displaying the moving image to be performed by the user, which provides an effect in that operations that are burdensome on the user can be omitted.

### Fourth Embodiment

Next, a fourth embodiment of the present invention will be described.

FIG. 11 is a flowchart illustrating a process for displaying a moving image indicating a procedure for clearing a paper jam in an image forming apparatus according to the fourth embodiment of the present invention. The processes indicated in the flowchart of FIG. 11 are implemented by the CPU 2001 executing programs that have been loaded from the HDD 2004 into the RAM 2002.

The above first through third embodiments describe cases where the reproduction of a moving image indicating a procedure for clearing a paper jam is started in response to an event of a cover of the apparatus being opened, and the reproduction of the moving image indicating a procedure for clearing the paper jam is ended in response to an event of the cover being closed. As opposed to this, the fourth embodiment describes processing performed in the case where a paper jam being cleared is communicated as an event for changing the location of the paper jam, from when the cover is opened to when the cover is closed.

Here, in moving images indicating an operation sequence for clearing a plurality of paper jams, reproduction of the first moving image indicating a procedure for clearing a paper jam is started in response to an event of the cover being opened. Then, when that paper jam has been cleared, the clearing of that paper jam is communicated as an event indicating a change to the location of the next paper jam, and reproduction of a second moving image indicating a procedure for clearing that paper jam is then started. This is repeated until the paper jam at the final paper jam location within the same cover is cleared, and the reproduction of the moving images indicating the procedures for clearing the paper jams is then ended when the cover is closed.

The fourth embodiment describes processing performed in the case where reproduction of a moving image indicating a procedure for clearing a paper jam in response to a cover in the apparatus being opened and reproduction of a moving image indicating a procedure for clearing a paper jam in response to an event indicating a change in location of the paper jam is a combination of manual reproduction and automatic reproduction. The flowchart in FIG. 11 illustrates processing performed in the case where the reproduction of the moving image indicating a procedure for clearing a paper jam is started in response to a manual operation performed by the user, when a cover in the apparatus is opened. Then, the reproduction of a moving image indicating a procedure for clearing a paper jam is started in response to a manual operation performed by the user, when an event indicating that the paper jam location has changed occurs.

This process is started while the moving image indicating the procedure for opening the cover of the apparatus is being reproduced. First, in S1101, the CPU 2001 determines whether or not that cover has been opened, and in the case where that cover has been opened, the process advances to S1102. In the case where it is not detected that the cover has been opened in S1101, the process of S1101 is repeated until it is detected that the cover has been opened. In S1102, the CPU 2001 obtains moving image data indicating a sequence for clearing the paper jam based on the location of the paper jam and then advances to S1103, where the process indicated in the flowchart of FIG. 7A, for starting the reproduction of the moving image in response to a manual operation made by the user, is carried out. The process then advances to S1104, where the CPU 2001 determines whether or not the paper jam at the current paper jam location has been cleared; in the case where the paper jam has not been cleared, the process returns to S1103, where the display of the moving image continues. However, in the case where it is determined in S1104 that the paper jam at the current paper jam location has been cleared, the process advances to S1105.

In S1105, the CPU 2001 determines whether a moving image indicating a procedure for clearing the final paper jam is being displayed; the process advances to S1106 in the case where the moving image is not the moving image indicating the procedure for clearing the final paper jam, whereas the process ends in the case where the moving image is the moving image indicating the procedure for clearing the final paper jam. It should be noted that it is determined that the moving image is the moving image indicating a procedure for clearing the final paper jam in the case where all of the paper jams occurring within the cover that is currently open have been cleared and a moving image indicating a procedure for closing the cover is being displayed. In S1106, the CPU 2001 obtains an event indicating that the location of the paper jam has changed. The process then returns to S1102, where the CPU 2001 obtains moving image data indicating a procedure for clearing the paper jam at the next paper jam location, and starts the reproduction of that moving image in response to a manual operation by the user.

In this manner, according to the fourth embodiment, the reproduction of a moving image indicating a procedure for clearing a paper jam is started in response to a manual operation made by the user, and thus the user can view that procedure in the moving image with certainty. In addition, in the case where a plurality of paper jams have occurred within the same cover, the reproduction of moving images indicating procedures for clearing those paper jams is started in response to manual operations made by the user, for each paper jam. This provides an effect in that the user can be made aware of operations for clearing each individual paper jam.

FIG. 12 is a flowchart illustrating a process for displaying a moving image indicating a procedure for clearing a paper jam in an image forming apparatus according to a variation on the fourth embodiment of the present invention. The processes indicated in the flowchart of FIG. 12 are implemented by the CPU 2001 executing programs that have been loaded from the HDD 2004 into the RAM 2002. The flowchart in FIG. 12 illustrates a case where a moving image indicating a procedure for clearing a paper jam is reproduced manually when a cover is opened, whereas a moving image indicating a procedure for clearing a paper jam is reproduced automatically in response to an event indicating a change in the paper jam location.

This process is started while the moving image indicating the procedure for opening the cover of the apparatus is being reproduced. First, in S1111, the CPU 2001 determines whether or not a cover of the apparatus has been opened; in the case where that cover has not been opened, S1111 is executed, whereas in the case with the cover has been opened, the process advances to S1102. In S1112, the CPU 2001 obtains moving image data indicating a procedure for clearing the paper jam at the corresponding location of the paper jam. The process then advances to S1113, where the CPU 2001 executes the process, shown in the flowchart of FIG. 7A, for starting the reproduction of a moving image in response to manual operations performed by the user. The process then advances to S1114, where the CPU 2001 determines whether or not the paper jam at the current paper jam location has been cleared; in the case where the paper jam has not been cleared, the display of the moving image continues. In other words, in S1114, in the case where the procedure illustrated in FIG. 7B is displayed but the paper jam has not been cleared, the process returns to S1118, whereas in the case where the procedure illustrated in FIG. 7A is displayed but the paper jam has not been cleared, the process returns to S1113. However, in the case where the CPU 2001 has determined in S1114 that the paper jam at the current paper jam location has been cleared, the process advances to S1115. In S1115, the CPU 2001 determines whether a moving image indicating a procedure for clearing the final paper jam has been displayed, and if that moving image has been displayed, the process ends. It is determined that the moving image indicating the procedure for clearing the final paper jam has been displayed as mentioned here in the case where all of the paper jams occurring within the cover have been cleared and a moving image indicating a procedure for closing the cover has then been displayed. In the case where it has been determined in S1115 that the moving image being displayed is not the moving image indicating the procedure for clearing the final paper jam, the process advances to S1116, where the CPU 2001 obtains an event indicating that the location of the paper jam has changed. The process then advances to S1117, where the CPU 2001 obtains moving image data indicating a procedure for clearing the paper jam at the corresponding location of the paper jam obtained in S1116. The process then advances to S1118, where the CPU 2001 executes a process for automatically reproducing the moving image based on that moving image data, in accordance with the flowchart illustrated in FIG. 7B; the process then advances to S1114.

In this manner, according to this variation on the fourth embodiment, the reproduction of a moving image indicating a procedure for clearing a paper jam is started in response to a manual operation made by the user, and thus the user can view that procedure with certainty. In addition, in the case where a plurality of paper jams have occurred within the same cover, the reproduction of moving images indicating procedures for clearing those paper jams is started automatically, for each paper jam. As a result, in the case of a plurality of paper jams within the same cover, moving images indicating procedures for clearing the paper jams are reproduced automatically, in sequence, each time a single paper jam is cleared, and the user need not carry out operations for reproducing the moving images each time.

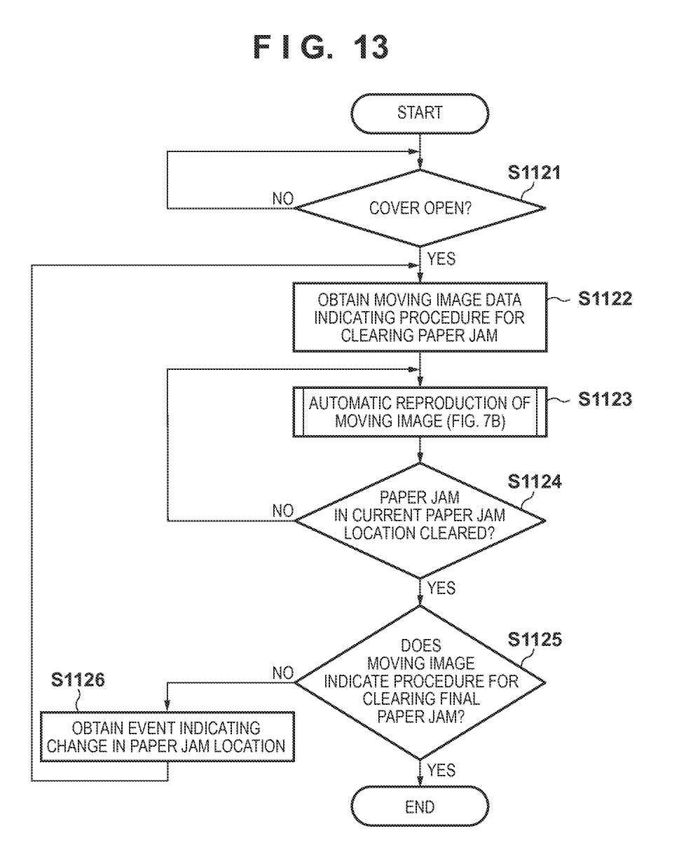

FIG. 13 is a flowchart illustrating a process for displaying a moving image indicating a procedure for clearing a paper jam in an image forming apparatus according to another variation on the fourth embodiment of the present invention. The processes indicated in the flowchart of FIG. 13 are implemented by the CPU 2001 executing programs that have been loaded from the HDD 2004 into the RAM 2002. The flowchart in FIG. 13 illustrates a case where a moving image indicating a procedure for clearing a paper jam is reproduced automatically when a cover is opened, an a moving image indicating a procedure for clearing a paper jam is reproduced automatically in response to an event indicating a change in the paper jam location as well.

This process is started when a paper jam is detected and a moving image indicating the procedure for opening the cover of the apparatus is being reproduced. First, in S1121, the CPU 2001 determines whether or not the cover of the apparatus has been opened, and in the case where that cover has been detected as being opened, the process advances to S1122. In the case where it is not detected that the cover has been opened in S1121, the process of S1121 is repeated until the cover has been opened. In S1122, the CPU 2001 obtains moving image data indicating a procedure for clearing the paper jam at the corresponding location of the paper jam. The process then advances to S1123, where the CPU 2001 executes a process for automatically reproducing the moving image, indicated by the flowchart in FIG. 7B. The process then advances to S1124, where the CPU 2001 determines whether or not the paper jam at the current paper jam location has been cleared; the process advances to S1125 in the case where it is determined that that paper jam has been cleared. On the other hand, in the case where it is determined in S1124 that the paper jam has not been cleared, the process advances to S1123, where the reproduction of the moving image is repeated until that paper jam is cleared.

In S1125, the CPU 2001 determines whether or not the moving image is a moving image indicating a procedure for clearing the final paper jam, and when such is the case, the process ends. Note that the moving image is determined to be a moving image indicating a procedure for clearing the final paper jam in the case where all of the paper jams within the cover that is currently open have been cleared and a moving image indicating a procedure for closing the cover is then displayed.

In the case where it has been determined in S1125 that the moving image being displayed is not the moving image indicating the procedure for clearing the final paper jam, the process advances to S1126, where the CPU 2001 obtains an event indicating that the location of the paper jam has changed. The process then returns to S1122, where the CPU 2001 obtains moving image data indicating a procedure for clearing the paper jam at the next location of the paper jam. In S1123, the moving image corresponding to that moving image data is reproduced automatically.

According to this variation, by automatically starting the reproduction of moving images indicating procedures for clearing the paper jams, the moving images indicating the procedures for clearing the paper jams are reproduced automatically, in sequence, each time a single paper jam is cleared, and the user need not carry out operations for reproducing the moving images each time. Accordingly, required moving images are reproduced and displayed automatically in sequence, thus providing an effect of enhanced usability for users accustomed to performing operations for addressing paper jams.

Although the aforementioned embodiments have been described independently from one another, switches for instructing the operations of the respective first through fourth embodiments may be provided in the image forming apparatus, and the image forming apparatus may then be instructed which of those operations to execute using the switches.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-261631, filed Nov. 29, 2012, which is hereby incorporated by reference herein in its entirety.

What is claimed is:

1. An image forming apparatus, the apparatus comprising:
a detecting unit configured to detect an occurrence of an event requiring maintenance in the image forming apparatus;
a manual moving image reproducing unit configured to start reproducing of a moving image indicating a procedure of maintenance in response to an instruction from a user;
a determination unit configured to determine whether or not the procedure indicated by the moving image has been executed; and
a control unit configured to cause the manual moving image reproducing unit to execute reproducing of a moving image indicating a procedure for opening a cover corresponding to a location where the event occurred in response to the detection of the event by the detecting unit, and in a case where the determination unit determines that the cover is opened, cause the manual moving image reproducing unit to execute reproducing of a moving image indicating a procedure for clearing the event.

2. An image forming apparatus, the apparatus comprising:
a detecting unit configured to detect the occurrence of an event requiring maintenance in the image forming apparatus;
a manual moving image reproducing unit configured to start reproducing of a moving image indicating a procedure of maintenance in response to an instruction from a user;
an automatic moving image reproducing unit configured to automatically start reproducing of a moving image indicating a procedure of maintenance;
a determination unit configured to determine whether or not the procedure indicated by the moving image has been executed; and
a control unit configured to cause the manual moving image reproducing unit to execute reproducing of a moving image indicating a procedure for opening a cover corresponding to a location where the event occurred in response to the detection of the event by the detecting unit, and in a case where the detection unit detects that the cover is opened, cause the automatic moving image reproducing unit to execute reproducing of a moving image indicating a procedure for clearing the event.

3. The image forming apparatus according to claim 2,
wherein in a case where a location where the event occurred is a same as a location where a previous event occurred, the control unit executes reproducing of a moving image indicating the procedure for opening the cover using the automatic moving image reproducing unit.

4. The image forming apparatus according to claim 1,
wherein in a case where the detecting unit detects occurrence of a plurality of events, the control unit executes reproducing of a moving image indicating the procedure for clearing the events using the manual moving image reproducing unit each time an individual event is cleared.

5. The image forming apparatus according to claim 2,
wherein in a case where the detecting unit detects occurrence of a plurality of events, the control unit executes reproducing of a moving image indicating the procedure for clearing the events using the automatic moving image reproducing unit each time an individual event is cleared.

6. The image forming apparatus according to claim 1,
wherein the event requiring maintenance includes at least one of the printing medium becoming jammed, ink being exhausted, and the printing media being exhausted.

7. The image forming apparatus according to claim 2,
wherein the event requiring maintenance includes at least one of the printing medium becoming jammed, ink being exhausted, and the printing media being exhausted.

8. The image forming apparatus according to claim 1, further comprising:
a storage unit configured to store moving image data expressing a moving image indicating the procedure for opening the cover corresponding to the location where the event occurred and moving image data expressing a moving image indicating the procedure for clearing the event.

9. The image forming apparatus according to claim 2, further comprising:
a storage unit configured to store moving image data expressing a moving image indicating the procedure for opening the cover corresponding to the location where the event occurred and moving image data expressing a moving image indicating the procedure for clearing the event.

10. A control method for controlling an image forming apparatus, the method comprising:
a detecting step of detecting the occurrence of an event requiring maintenance in the image forming apparatus;
a manual moving image reproducing step of starting reproducing of a moving image indicating a procedure of maintenance in response to an instruction from a user;
a determination step of determining whether or not the procedure indicated by the moving image is executed; and
a control step of causing reproducing of a moving image indicating a procedure for opening a cover corresponding to a location where the event occurred in response to the detection of the event in the detecting step to be executed in the manual moving image reproducing step, and in a case where it is determined in the determination step that the cover is opened, causing reproducing of a moving image indicating a procedure for clearing the event to be executed in the manual moving image reproducing step.

11. A control method for controlling an image forming apparatus, the method comprising:
a detecting step of detecting the occurrence of an event requiring maintenance in the image forming apparatus;
a manual moving image reproducing step of starting reproducing of a moving image indicating a procedure of maintenance in response to an instruction from a user;
an automatic moving image reproducing step of automatically starting reproducing of a moving image indicating a procedure of maintenance;
a determination step of determining whether or not the procedure indicated by the moving image is executed; and
a control step of causing reproducing of a moving image indicating a procedure for opening a cover corresponding to a location where the event occurred in response to the detection of the event in the detecting step to be executed in the manual moving image reproducing step, and in a case where it is determined in the determination step that the cover is opened, causing reproducing of a moving image indicating a procedure for clearing the event to be executed in the automatic moving image reproducing step.

12. A computer-readable storage medium storing a program for controlling an image forming apparatus, the program causing a computer to execute:
a detecting step of detecting the occurrence of an event requiring maintenance in the image forming apparatus;
a manual moving image reproducing step of starting reproducing of a moving image indicating a procedure of maintenance in response to an instruction from a user;
a determination step of determining whether or not the procedure indicated by the moving image is executed; and
a control step of causing reproducing of a moving image indicating a procedure for opening a cover corresponding to a location where the event occurred in response to the detection of the event in the detecting step to be executed in the manual moving image reproducing step, and in a case where it is determined in the determination step that the cover is opened, causing reproducing of a moving image indicating a procedure for clearing the event to be executed in the manual moving image reproducing step.

13. A computer-readable storage medium storing a program for controlling an image forming apparatus, the program causing a computer to execute:
a detecting step of detecting the occurrence of an event requiring maintenance in the image forming apparatus;
a manual moving image reproducing step of starting reproducing of a moving image indicating a procedure of maintenance in response to an instruction from a user;
an automatic moving image reproducing step of automatically starting reproducing of a moving image indicating a procedure of maintenance;
a determination step of determining whether or not the procedure indicated by the moving image is executed; and
a control step of causing reproducing of a moving image indicating a procedure for opening a cover corresponding to a location where the event occurred in response to the detection of the event in the detecting step to be executed in the manual moving image reproducing step, and in a case where it is determined in the determination step that the cover is opened, causing reproducing of a moving image indicating a procedure for clearing the event to be executed in the automatic moving image reproducing step.
